(19) United States
(12) Patent Application Publication
(10) Pub. No.: US 2013/0021023 A1
(43) Pub. Date: Jan. 24, 2013

(54) POSITION SENSOR

(71) Applicants: Masahisa Niwa, Osaka (JP); Kunitaka Okada, Osaka (JP)

(72) Inventors: Masahisa Niwa, Osaka (JP); Kunitaka Okada, Osaka (JP)

(73) Assignee: PANASONIC CORPORATION, Osaka (JP)

(21) Appl. No.: 13/637,784

(22) PCT Filed: Feb. 23, 2011
(86) PCT No.: PCT/IB11/00376

§ 371 Date: Sep. 27, 2012

(30) Foreign Application Priority Data
Jun. 10, 2010 (JP) 2010-133222
Jun. 10, 2010 (JP) 2010-133226

(51) Int. Cl. G01B 7/14

(52) U.S. Cl. 324/207.15

(57) ABSTRACT

A position sensor includes a detection coil printed on a surface of a substrate formed of a dielectric material; and a detection body arranged in an opposing relationship with the detection coil and displaced along a specified orbit with respect to the detection coil in response to a displacement of a target object. The position sensor detects the displacement of the target object based on an inductance of the detection coil varying depending on the displacement of the detection body. At least one of the detection coil and the detection body is formed into such a shape that a change rate of the inductance of the detection coil with respect to the displacement of the detection body is kept constant.

### FIELD OF THE INVENTION

The present invention relates to a position sensor for detecting a displacement of a target object.

### BACKGROUND OF THE INVENTION

Conventionally, there have been provided various position sensors for detecting a displacement of a target object (e.g., a rotation amount, a rotation angle or a rotation position of a rotating target object). For example, there is available a position sensor as disclosed in Patent Document 1. A displacement sensor (position sensor) described in Patent Document 1 includes a detection coil wound around a tubular core formed of a non-magnetic material and a tubular electric conductor arranged near the inside or outside of the detection coil and capable of displacing in an axial direction of the detection coil.

An oscillation signal of a frequency corresponding to an inductance of the detection coil varying depending on the distance between the detection coil and the electric conductor is outputted from an oscillation circuit. The displacement of the electric conductor is detected based on the oscillation signal. Accordingly, the displacement of the target object can be detected by detecting the displacement of the electric conductor moving together with the target object by using an inductance change of the detection coil.

In the position sensor described in Patent Document 1, however, the core needs to be inserted into the electric conductor. This leads to an increase in the thickness of a case accommodating the electric conductor and the core, which poses a problem in that it is difficult to form a thin position sensor. In recent years, there is proposed a position sensor capable of solving the problem noted above. Such position sensor will now be described with reference to the drawings. In the following description, the up-down direction in FIG. 6 will be defined as an up-down direction.

As shown in FIG. 10, the position sensor includes a first dielectric substrate 100 having an upper surface printed with a pair of detection coils 100a and a second dielectric substrate 101 having a lower surface printed with a pair of detection coils (not shown). The position sensor further includes a rotor block 104 having a pair of detection bodies 102a formed into a fan-like shape by a non-magnetic material and a holder 103 for holding the detection bodies 102a. The first and the second dielectric substrate 100 and 101 and the rotor block 104 are accommodated in a case 105 which includes a box-shaped body 105a with one open surface and a cover 105b closing the open surface of the body 105a.

Precisely speaking, each of detection bodies 102a is not identical to a fan-like shape but is more likely identical to a geometric figure obtained by cutting away a smaller fan-like sector from a fan-like body. Thus, in the following description, the term “fan-like shape” refers to “the geometric figure obtained by cutting away a smaller fan-like sector from the fan-like body.”

Hereinafter, the operation of the position sensor will be briefly described. If the holder 103 of the rotor block 104 moving together with the target object (not shown) is rotated along with the displacement of the target object, the respective detection bodies 102a are deviated from each other at 180 degrees and moved along a circumferential orbit in response to the rotation of the holder 103. Similar to the conventional example described in Patent Document 1, an oscillation signal of a frequency corresponding to an inductance of the detection coils varying depending on the relative position between the detection bodies 102a and the two pairs of detection coils is outputted from an oscillation circuit. By detecting the displacement of the detection bodies 102a based on the oscillation signal, it is possible to detect the information on the relative position between the detection bodies 102a and the detection coils, i.e., the rotating amount of the target object moving together with the rotor block 104. The specific detection method is conventionally known as disclosed in Patent Document 1 and, therefore, will not be described in detail herein.

Patent Document 1: Japanese Patent Application Publication No. 2008-292376

In the position sensor stated above, it is desirable to maintain the inductance change rate of the detection coils with respect to the displacement of the target object at a constant level. That is, it is desirable that the inductance of the detection coils with respect to the displacement of the target object be linearly changed. In the latter conventional example stated above, however, the route of an eddy current flowing through each of the detection bodies 102a is changed depending on the displacement of each of the detection bodies 102a. Moreover, the current density differs from place to place. Therefore, the inductance of the detection coils is non-linearly changed with respect to the displacement of the detection bodies 102a. For that reason, the inductance of the detection coils is non-linearly changed with respect to the displacement of the target object. This poses a problem in that it is difficult to secure high enough linearity.

### SUMMARY OF THE INVENTION

In view of the above, the present invention provides a position sensor capable of enhancing the linearity of inductance change of a detection coil with respect to a displacement of a target object.

In accordance with a first aspect of the present invention, there is provided a position sensor including: a detection coil printed on a surface of a substrate formed of a dielectric material; and a detection body arranged in an opposing relationship with the detection coil and displaced along a specified orbit with respect to the detection coil in response to a displacement of a target object. The displacement of the target object is detected based on an inductance of the detection coil varying depending on the displacement of the detection body, and at least one of the detection coil and the detection body is formed into such a shape that a change rate of the inductance of the detection coil with respect to the displacement of the detection body is kept constant.

Further, the detection body may be formed into such a shape that a radial width of the detection body is changed along a displacing direction of the detection body.

Further, the detection coil may be formed into such a shape that a radial width of the detection coil is changed along a displacing direction of the detection body.

Further, the detection body may be formed into such a shape that a distance between the detection body and the detection coil is changed along a displacing direction of the detection body.

In accordance with a second aspect of the present invention, there is provided a position sensor including: a detection coil printed on a surface of a substrate formed of a dielectric material; and a detection body arranged in an opposing relationship with the detection coil and displaced along a specified orbit with respect to the detection coil in response to a displacement of a target object. The displacement of the target object is detected based on an inductance of the detection coil varying depending on the displacement of the detection body, and the detection coil includes a plurality of first turns wound to surround a space having a specified length and extending in a displacing direction of the detection body and one or more second turns turned back and wound to extend across the space.

Further, the substrate may be formed of a multi-layer substrate. Further, the detection coil may be printed on each layer of the substrate, and the second turns of detection coils of at least two layers of the substrate may be arranged not to overlap with each other in a thickness direction of the substrate.

In accordance with the first aspect of the present invention, at least one of the detection coil and the detection body is formed into such a shape that the change rate of the inductance of the detection coil with respect to the displacement of the detection body is kept constant. This makes it possible to linearly change the inductance of the detection coil with respect to the displacement of the detection body. It is therefore possible to enhance the linearity of the inductance change of the detection coil with respect to the displacement of the target object changing together with the displacement of the detection body.

In accordance with the second aspect of the present invention, the magnetic flux density in the turn-back sections of the second turn of the detection coil is changed step by step. This makes it possible to substantially linearly change the inductance of the detection coil with respect to the displacement of the detection body. It is therefore possible to enhance the linearity of the inductance change of the detection coil with respect to the displacement of the target object changing together with the displacement of the detection body.

### BRIEF DESCRIPTION OF THE DRAWINGS

The objects and features of the present invention will become apparent from the following description of the preferred embodiments, given in conjunction with the accompanying drawings, in which:

FIG. 1A is an exploded perspective view showing a position sensor in accordance with a first embodiment of the present invention and FIG. 1B is a plan view showing a rotor block of the position sensor;

FIG. 2 is a graph showing the characteristics of the inductance change with respect to the rotation angle of a target object in the position sensor of the first embodiment;

FIG. 3 is a plan view of a first dielectric substrate illustrating another configuration of the detection coil in the position sensor of the first embodiment;

FIG. 4A is a partial section view showing another configuration of the detection body in the position sensor of the first embodiment, in which case one end portion of the detection body is bent, and FIG. 4B is a partial section view showing another configuration of the detection body in the position sensor of the first embodiment, in which case the thickness of one end portion of the detection body is changed;

FIG. 5A is a schematic view showing a configuration of a linear-motion-type position sensor, and FIG. 5B is a plan view of a detection coil uniformly wound along a displacing direction of a detection body, and FIG. 5C is a plan view of the detection coil non-uniformly wound along the displacing direction of the detection body;

FIG. 6A is an exploded perspective view showing a position sensor in accordance with a second embodiment of the present invention and FIG. 6B is a plan view showing a first dielectric substrate of the position sensor;

FIG. 7 is a graph showing the characteristics of the inductance change with respect to the rotation angle of a target object in the position sensor of the second embodiment;

FIG. 8A is a plan view of the first dielectric substrate illustrating another configuration of the position sensor of the second embodiment and FIG. 8B is a graph showing the characteristics of the inductance change with respect to the rotation angle of a target object;

FIG. 9 is a plan view of the detection coil of a linear-motion-type position sensor, which is formed of a first turn and a second turn; and

FIG. 10 is an exploded perspective view showing a conventional position sensor.

### DETAILED DESCRIPTION OF THE EMBODIMENTS

Hereinafter, embodiments of the present invention will now be described in detail with reference to the accompanying drawings which form a part hereof. Like reference numerals will be given to like parts throughout the drawings, and redundant description thereof will be omitted.

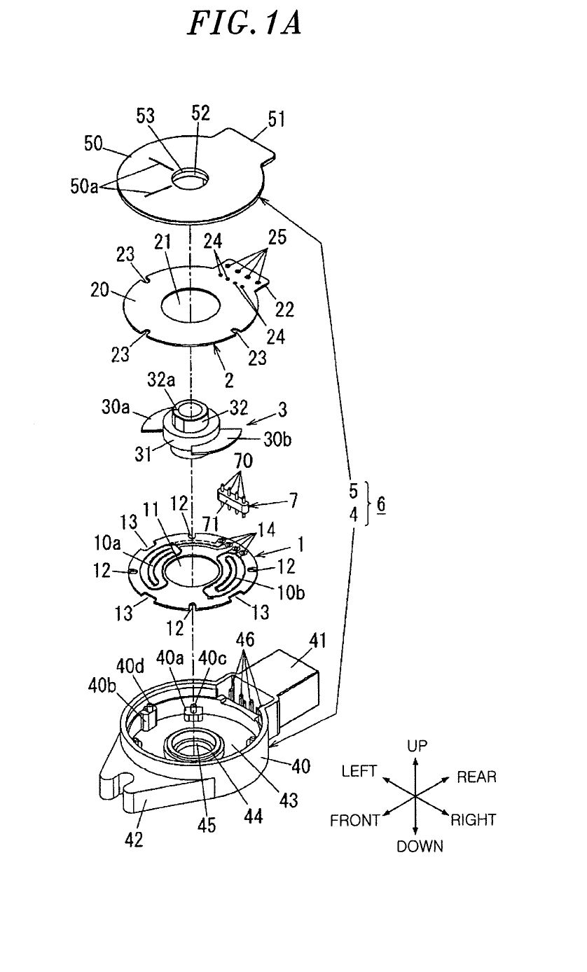

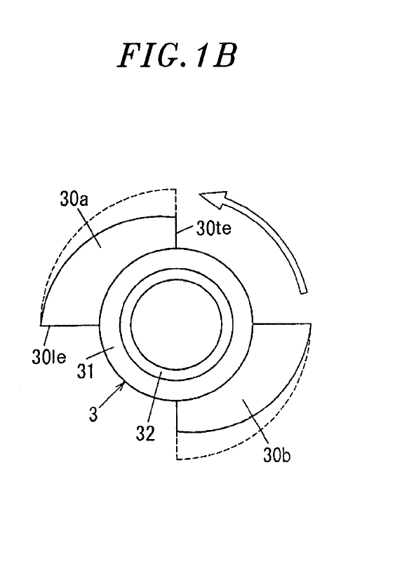

In the following description, the up-down, left-right and front-rear directions are defined on the basis of the directions shown in FIG. 1A. In the following description, the term “detection coils Co” refers to both the detection coils 10a and 10b of a first dielectric substrate and the detection coils of a second dielectric substrate to be described later.

### First Embodiment

As shown in FIG. 1A, a position sensor of a first embodiment includes a first dielectric substrate 1 having an upper surface printed with a pair of detection coils 10a and 10b and a second dielectric substrate 2 having a lower surface printed with a pair of detection coils (not shown). The position sensor further includes a rotor block 3 having a pair of detection bodies 30a and 30b formed into a fan-like shape by a non-magnetic material (e.g., an aluminum plate) and a holder 31 for holding the detection bodies 30a and 30b. The first and the second dielectric substrate 1 and 2 and the rotor block 3 are accommodated in a case 6 which includes a box-shaped body 4 with one open surface and a cover 5 closing the open surface of the body 4.

The first dielectric substrate 1 is formed into a disc shape. A circular hole 11 bored in the thickness direction is formed in a central region of the first dielectric substrate 1. The detection coils 10a and 10b are printed on the upper surface of the first dielectric substrate 1 in an opposing relationship across the hole 11. The detection coils 10a and 10b are patterned to have a fan-like contour. A plurality of (four, in the illustrated example) relatively narrow cutouts 12 and a plurality of (three, in the illustrated example) relatively wide cutouts 13 are alternately arranged at a regular interval along an outer peripheral edge of the first dielectric substrate 1. Four through-holes 14 are formed in a rear end region of the first dielectric substrate 1. The through-holes 14 are arranged side by side along a circumferential direction. Lands (not shown) electrically connected to coil terminals of the detection coils 10a and 10b on a lower surface of the first dielectric substrate 1 are printed at open ends of the through-holes 14.

The second dielectric substrate 2 includes a main piece 20 formed into a disc shape and provided with a circular hole 21, which is bored in the thickness direction and formed in a central region of the main piece 20, and a rectangular terminal piece 22 integrally formed with the main piece 20 to protrude from a rear peripheral edge of the main piece 20. A pair of detection coils is printed on the lower surface of the second dielectric substrate 2 in an opposing relationship across the hole 21. Although not shown in the drawings, the detection coils are formed to have the same shape and dimension as the detection coils 10a and 10b of the first dielectric substrate 1.

In an outer peripheral edge of the second dielectric substrate 2, a plurality of (three, in the illustrated example) narrow cutouts 23 is formed at a regular interval. In a rear end portion of the main piece 20 (in the portion of the main piece 20 connected to the terminal piece 22), four through-holes 24 are formed side by side along a circumferential direction. In the terminal piece 22, four through-holes 25 are formed side by side along the left-right direction. On an upper surface of the second dielectric substrate 2, lands (not shown) electrically connected to coil terminals of the detection coils formed on the lower surface of the second dielectric substrate 2 are printed at open ends of the through-holes 24. Four lands (not shown) electrically connected to the aforementioned lands by conductive patterns not shown in the drawings are printed at open ends of the through-holes 25 of the terminal piece 22.

Further, one detection coil 10a formed in the first dielectric substrate 1 and one detection coil (the detection coil opposing to the detection coil 10a in the up-down direction) formed in the second dielectric substrate 2 are electrically connected to each other through a terminal block 7. Similarly, the other detection coil 10b formed in the first dielectric substrate 1 and the other detection coil (the detection coil opposing to the detection coil 10b in the up-down direction) formed in the second dielectric substrate 2 are electrically connected to each other through the terminal block 7.

The terminal block 7 includes four terminal pins 70 and an insulating body 71 for holding the central portions of the terminal pins 70. Lower end portions of the respective terminal pins 70 are inserted into the four through-holes 14 of the first dielectric substrate 1 and are soldered to the lands printed on the lower surface of the first dielectric substrate 1. Upper end portions of the respective terminal pins 70 are inserted into the four through-holes 24 of the second dielectric substrate 2 and are soldered to the lands printed on the upper surface of the second dielectric substrate 2. That is, the coil terminals of the detection coils 10a and 10b formed on the first dielectric substrate 1 and the coil terminals of the detection coils formed on the second dielectric substrate 2 are electrically connected to each other through the four terminal pins 70.

The second dielectric substrate 2 is provided with circuits serving as a detection unit (not shown) for detecting the displacement of a target object (not shown) based on an inductance of the detection coils Co varying depending on the displacement of the detection bodies 30a and 30b.

The detection unit includes an oscillation circuit for outputting an oscillation signal having a frequency corresponding to the inductance of the detection coils Co and an oscillation cycle measuring circuit for outputting a signal corresponding to a cycle of the oscillation signal outputted from the oscillation circuit. The detection unit further includes a square circuit calculating and outputting a square value of the signal outputted from the oscillation cycle measuring circuit, a temperature compensation circuit for compensating temperature changes of the square value calculated in the square circuit and a signal processing circuit for detecting the displacement of the detection bodies 30a and 30b based on the signal outputted from the temperature compensation circuit. These circuits are conventionally known as disclosed Patent Document 1 and, therefore, will not be described in detail herein.

While the first and the second dielectric substrate 1 and 2 are formed of a single-layer substrate in the first embodiment, they may be formed of a multiple-layer substrate (e.g., a four-layer substrate). In that case, a pair of detection coils can be printed on each layer of each of the first and the second dielectric substrate 1 and 2.

The holder 31 of the rotor block 3 is formed into a cylindrical shape by a synthetic resin material. The holder 31 holds the detection bodies 30a and 30b simultaneously molded therewith so that the detection bodies 30a and 30b protrude from a circumferential surface of the holder 31 in the left-right direction. An intermediate body 32 formed into a cylindrical shape by a metallic material and rotating together with the holder 31 is fixed inside the holder 31 by an appropriate method such as press-fit, simultaneous molding or the like. The intermediate body 32 is fixed to a shaft (not shown) moving together with a target object. A fixing-purpose D-cut is formed on the outer circumferential surface of the intermediate body 32. A mark 32a extending in a radial direction of the intermediate body 32 is engraved on an upper end surface of the intermediate body 32. Relying on the mark 32a and marks 50a formed on an upper surface of a main portion 50 of the cover 5 to be described later, it is possible to visually recognize the positions of the respective detection bodies 30a and 30b on the circumferential orbit from the outside of the cover 5.

The body 4 includes a cylindrical storage portion 40 formed of a synthetic resin molded article and provided with an open upper surface and a flat bottom, and a rectangular box-shaped connector housing portion 41 protruding rearward from the rear end region of the circumferential surface of the storage portion 40. A triangular flange portion 42 protruding frontward is provided in the front end region of the circumferential surface of the storage portion 40. A magnetic shield 43 formed by a non-magnetic material such as an aluminum plate into a cylindrical shape with a flat bottom is simultaneously molded with the storage portion 40. The magnetic shield 43 is exposed to the inside of the storage portion 40.

Two kinds of ribs 40a and 40b, which are different in height from an inner bottom surface, protrudes from an inner circumferential surface of the storage portion 40. Ribs 40c and 40d having a smaller size compared to the ribs 40a and 40b are installed to protrude upward from the ribs 40a and 40b, respectively. The ribs 40c protruding from upper surfaces of the ribs 40a having a smaller height are fitted to the narrow cutouts 12 of the first dielectric substrate 1. On the other hand, the ribs 40b having a larger height are fitted to the wide cutouts 13 of the first dielectric substrate 1. The ribs 40d protruding from upper surfaces of the ribs 40b having a larger height can be fitted to the narrow cutouts 23 of the second dielectric substrate 2. Accordingly, the first dielectric substrate 1 is fixed to the upper surfaces of the ribs 40a having a smaller height while the second dielectric substrate 2 is fixed to the upper surfaces of the ribs 40b having a larger height.

The connector housing portion 41 is formed into a closed-bottom square tube shape. Four contacts 46 are simultaneously molded with an inner bottom surface of the connector housing portion 41 so that the contacts 46 can be arranged side by side in the left-right direction. A front end section (connected to the storage portion 40) of the connector housing portion 41 has an open upper surface. The terminal piece 22 of the second dielectric substrate 2 is received within the front end section of the connector housing portion 41. The respective contacts 46 are formed by bending rod-shaped metallic materials into an L-shape. Upper end portions of the contacts 46 are inserted into the respective through-holes 25 of the terminal piece 22 of the second dielectric substrate 2 and are soldered to the lands printed at open ends of the respective through-holes 25.

The cover 5 includes a disc-shaped main portion 50 and a rectangular plate-like terminal cover portion 51 protruding from a rear edge of the main portion 50. The main portion 50 and the terminal cover portion 51 are integrally formed with each other by a synthetic resin molded article. The cover 5 is attached to an upper surface of the body 4 in such a manner that the open upper surface of the storage portion 40 of the body 4 is closed by the main portion 50 while the open upper surface of the front end section of the connector housing portion 41 is closed by the terminal cover portion 51. A magnetic shield (not shown) formed into a ring shape by a non-magnetic material such as aluminum or the like is simultaneously molded with the main portion 50 and is exposed to a lower surface of the main portion 50.

The body 4 and the cover 5 are respectively provided with thrust bearing portions 44 and 52 for receiving thrust load of the rotor block 3 and radial bearing portions 45 and 53 for receiving radial load of the rotor block 3.

The thrust bearing portion 44 of the body 4 is formed into a cylindrical shape to protrude upward from a central region of a bottom surface of the storage portion 40. An upper end surface of the thrust bearing portion 44 is configured to support the lower surface of the holder 31 of the rotor block 3, thereby receiving the thrust load. The radial bearing portion 45 of the body 4 is formed of a peripheral edge portion of the circular bore opened at a center of a lower surface of the body 4. The radial bearing portion 45 is configured to support an outer circumferential surface of a lower end portion of the intermediate body 32 inserted into the thrust bearing portion 44, thereby receiving the radial load.

The thrust bearing portion 52 of the cover 5 is formed into a cylindrical shape to protrude downward from a central region of a lower surface of the cover 5. A lower end surface of the thrust bearing portion 52 is configured to support an upper surface of the holder 31 of the rotor block 3, thereby receiving the thrust load. The radial bearing portion 53 of the cover 5 is formed of a peripheral edge portion of the circular bore opened at a center of an upper surface of the cover 5. The radial bearing portion 53 is configured to support an outer circumferential surface of an upper end portion of the intermediate body 32 inserted into the thrust bearing portion 52, thereby receiving the radial load.

If the shaft moving together with the target object is inserted into the intermediate body 32 and if the shaft and the intermediate body 32 are fixed together, the intermediate body 32, i.e., the rotor block 3, is rotated together with the shaft. Thus, the respective detection bodies 30a and 30b are rotated along the circumferential obit.

The operation of the position sensor in accordance with the present invention will now be briefly described. When the intermediate body 32 of the rotor block 3 moving together with the target object is rotated in response to the displacement of target object, the detection bodies 30a and 30b are deviated from each other at 180 degrees and moved along the circumferential orbit in response to the rotation of the intermediate body 32. As in the conventional example disclosed in Patent Document 1, an oscillation signal having a frequency corresponding to an inductance of the detection coils Co varying with the relative position between the detection bodies 30a and 30b and two pairs of the detection coils is outputted from the oscillation circuit. By detecting the displacement of the detection bodies 30a and 30b based on the oscillation signal, it is possible to detect the information on the relative position between the detection bodies 30a and 30b and the detection coils Co, that is, the rotation amount (rotation angle) of the target object moving together with the intermediate body 32. The specific detection method is conventionally known as disclosed in Patent Document 1 and, therefore, will not be described in detail herein.

In the present embodiment, as shown in FIG. 1B, each of the detection bodies 30a and 30b is formed such that the radial width thereof is non-linearly changed along the displacing direction thereof (the circumferential orbit). More specifically, each of the detection bodies 30a and 30b is formed such that, when the detection bodies 30a and 30b are rotated counterclockwise, the radial width thereof is decreased as the area of each of the detection bodies 30a and 30b overlapping with the detection coils Co in the up-down direction (hereinafter referred to as “overlapping area”) grows larger. That is to say, the width of the trailing end portion 30te is smaller than the width of the leading end portion 30le in the rotation direction of the detection bodies 30a and 30b. For that reason, if the overlapping area is small, the inductance change of the detection coils Co per unit rotation angle of the target object becomes larger. If the overlapping area is large, the inductance change of the detection coils Co per unit rotation angle of the target object becomes smaller. In other words, each of the detection bodies 30a and 30b is formed into such a shape that the change rate of the inductance of the detection coils Co with respect to the displacement of the detection bodies 30a and 30b becomes constant.

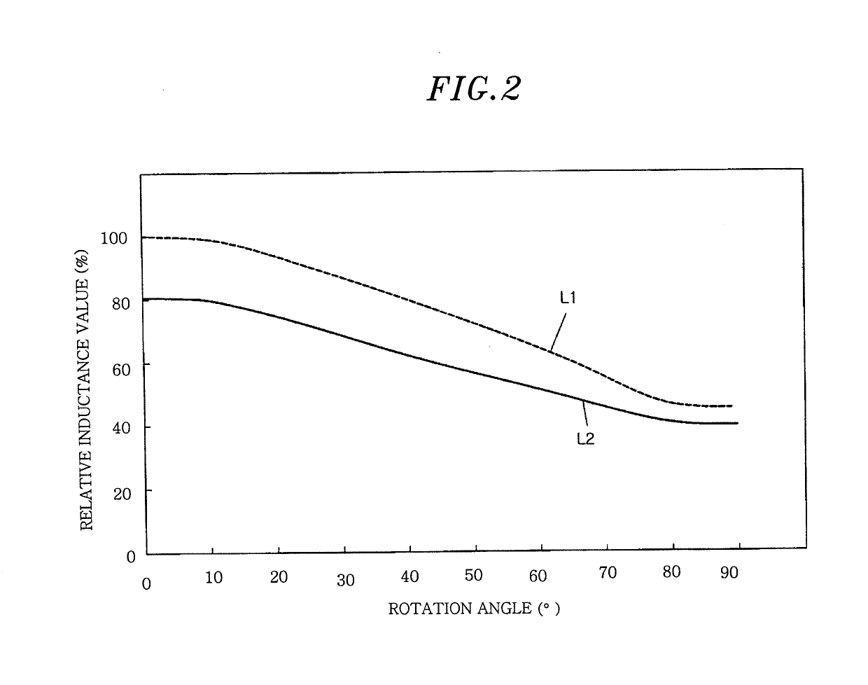

For example, if each of the detection bodies 30a and 30b is formed such that the radial width thereof is kept constant along the circumferential orbit as in the conventional example, the inductance change of the detection coils Co with respect to the rotation angle of the target object becomes non-linear as indicated by a dashed line L1 in FIG. 2. In FIG. 2, the inductance of the detection coils Co is 100% when the rotation angle of the target object is zero in case of employing the conventional detection bodies 30a and 30b (in a state that the respective detection bodies 30a and 30b and the detection coils Co do not overlap with each other in the up-down direction). On the other hand, in case of employing the detection bodies 30a and 30b of the present embodiment, the inductance change of the detection coils Co with respect to the rotation angle of the target object becomes substantially linear as indicated by a solid line L2 in FIG. 2.

As described above, each of the detection bodies 30a and 30b of the first embodiment is formed in such a shape that the change rate of the inductance of the detection coils Co with respect to the displacement of the detection bodies 30a and 30b becomes constant. This makes it possible to linearly change the inductance of the detection coils Co with respect to the detection bodies 30a and 30b. It is therefore possible to enhance the linearity of the inductance change of the detection coils Co with respect to the displacement of the target object changing together with the displacement of the detection bodies 30a and 30b. In the characteristics of the inductance change with respect to the rotation angle of the target object shown in FIG. 2, the inductance change becomes non-linear when the rotation angle of the target object is in a range close to 90 degree. The aforementioned change of the shape of the respective detection bodies 30a and 30b is effective in enhancing the linearity of such range where the inductance change becomes non-linear.

While the respective detection bodies 30a and 30b are formed of a non-magnetic material in the first embodiment, they may be formed of a magnetic material having high magnetic permeability. In that case, the characteristics of the inductance change with respect to the rotation angle of the target object are opposite to the characteristics available when the respective detection bodies 30a and 30b are formed of a non-magnetic material. That is to say, the inductance of the detection coils Co is increased as the rotation angle of the target object is increased. In this case, it is equally possible to enhance the linearity characteristics of the inductance change with respect to the rotation angle of the target object.

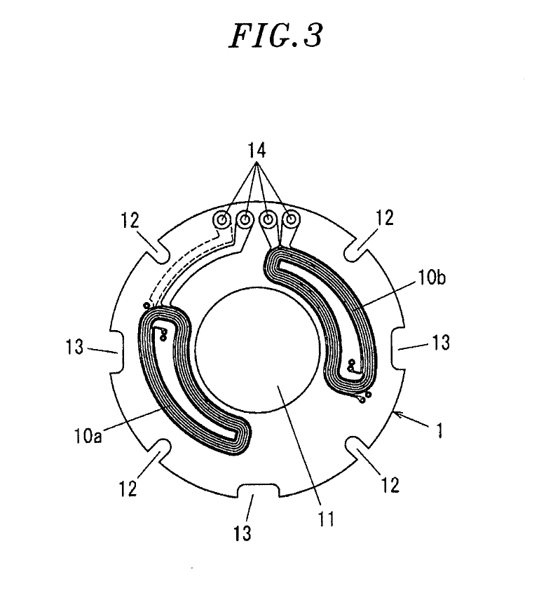

In the foregoing description, the respective detection bodies 30a and 30b are formed into a non-linear shape. Alternatively, each of the detection bodies 30a and 30b may be formed such that the radial width thereof is kept constant, and the shape of each of the detection coils of the first and the second dielectric substrate 1 and 2 may be formed into a non-linear shape as shown in FIG. 3 (only the first dielectric substrate 1 is shown in FIG. 3). In other words, similar to the case where the respective detection bodies 30a and 30b are formed into a non-linear shape, each of the detection coils of the first and the second dielectric substrate 1 and 2 is formed such that the radial width thereof is decreased as the overlapping area grows larger. In case where the respective detection coils are formed into a non-linear shape in this manner, it is possible to obtain the same effects as stated above.

Further, both the radial widths of the detection bodies 30a and 30b and the radial widths of the detection coils of the respective dielectric substrates 1 and 2 may be non-linearly changed such that the inductance of the detection coils Co can be linearly changed with respect to the displacement of the detection bodies 30a and 30b.

In the conventional example disclosed in Patent Document 1, the effects as stated above may be obtained by changing the winding number of detection coils along the axial direction of a core. However, there is posed a problem in that processing variations tends to occur in the winding process in which the detection coils are wound on the core.

On the other hand, in case of a so-called pattern coil formation process in which the detection coils are printed on the dielectric substrates, variations in the shape of the detection coils are hardly generated by the etching exposure pattern. Therefore, the process of the present embodiment is preferred.

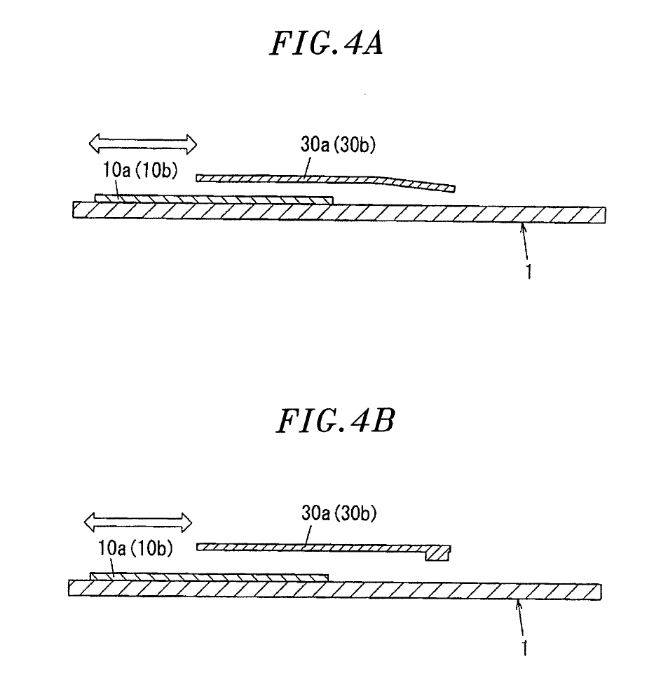

Alternatively, each of the detection bodies 30a and 30b may be formed into such a shape that a distance (vertical distance) between the detection bodies 30a and 30b and the detection coils of the respective dielectric substrates 1 and 2 is changed along the displacing direction of the detection bodies 30a and 30b. For example, as shown in FIG. 4A, each of the detection bodies 30a and 30b may be bent downward such that the detection bodies 30a and 30b come close to the detection coils 10a and 10b, respectively, as the overlapping area grows larger. Further, as shown in FIG. 4B, a thickness of a rear end portion of each of the detection bodies 30a and 30b may be increased such that the detection bodies 30a and 30b come close to the detection coil 10a and 10b, respectively, as the overlapping area grows larger. In any case, it is possible to obtain the same effects as stated above.

In FIG. 4A, it is assumed that the detection coils are provided in only the first dielectric substrate 1. While the shape of each of the detection bodies 30a and 30b is changed in FIGS. 4A and 4B so as to change the distance between the detection bodies 30a and 30b and the detection coils 10a and 10b of the first dielectric substrate 1, it may be possible to change the distance between the detection bodies 30a and 30b and the detection coils of the second dielectric substrate 2. In such a case, for example, when the case of bending each of the detection bodies 30a and 30b is employed, it is assumed that the detection coils are provided in only the second dielectric substrate 2.

In the conventional example disclosed in Patent Document 1, the effects stated above may be obtained by changing the distance between the conductor and the detection coil along the axial direction of the conductor. However, since the conductor has a tubular shape and involves a difficulty in processing the same, a problem is posed in that processing variations are easy to occur. On the other hand, in case where the respective detection bodies 30a and 30b are made as in the present embodiment, variations in shape are hardly generated by the shape of the punching die for sheet-metal processing. Therefore, the process of the present embodiment is preferred.

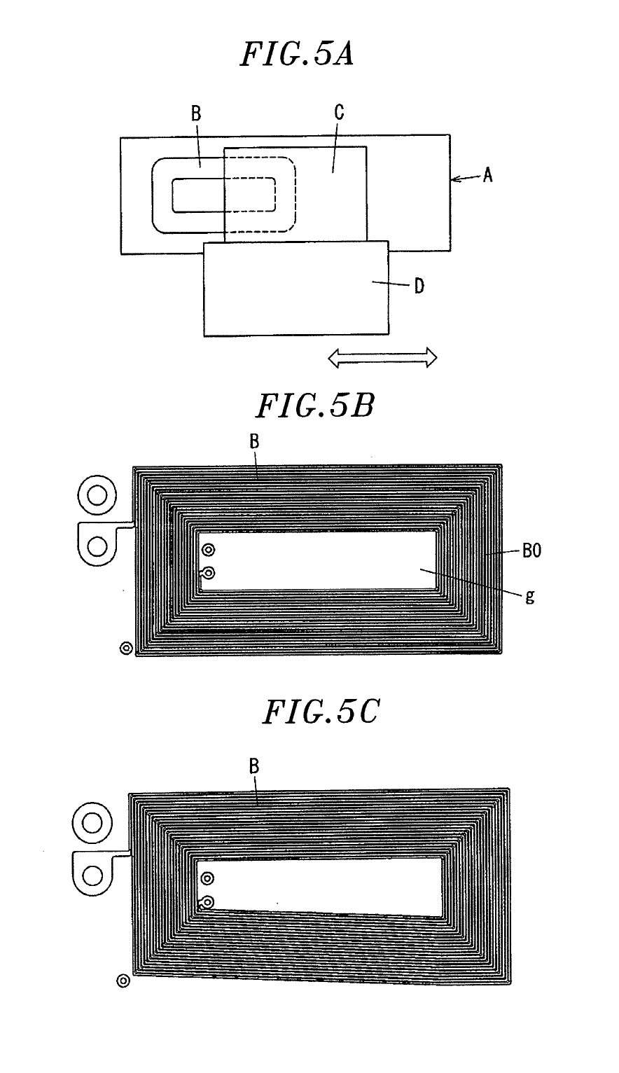

While the rotary position sensor in which the detection bodies 30a and 30b are displaced along the circumferential orbit has been described in the present embodiment, it may be possible to employ a linear-motion-type position sensor in which a detection body is displaced along a linear orbit. One embodiment of the linear-motion-type position sensor will now be described with reference to the drawings. As shown in FIG. 5A, the linear-motion-type position sensor includes a rectangular plate-like dielectric substrate A having an upper surface printed with a rectangular shaped detection coil B and a detection body C formed into a rectangular shape by a non-magnetic material (e.g., aluminum). The detection body C is provided in a movable body D which holds the detection body C such that the detection body C can be displaced along the longitudinal direction of the dielectric substrate A. The movable body D is provided in a target object such that the movable body D can be displaced together with the target object. While not shown in the drawings, the dielectric substrate A is provided with circuits serving as a detection unit for detecting a displacement of the target object based on an inductance of the detection coil B varying with a displacement of the detection body C.

Hereinafter, the operation of the linear-motion-type position sensor will be briefly described. When the movable body D moving together with the target object is displaced in conjunction with the displacement of the target object, the detection body C is displaced along the linear orbit together with the movable body D.

As in the embodiment of the rotary position sensor, an oscillation signal having a frequency corresponding to the inductance of the detection coil B varying depending on a relative position between the detection body C and the detection coil B is outputted from an oscillation circuit. By detecting the displacement of the detection body C based on the oscillation signal, it is possible to detect the information on the relative position between the detection body C and the detection coil B, i.e., the displacement amount of the target object moving together with the movable body D.

In this embodiment, as shown in FIG. 5C, the detection coil B is formed such that the transverse width thereof is changed along the displacing direction of the detection body C. In other words, the detection coil B is formed such that the transverse width thereof is decreased as the overlapping area of the detection body C and the detection coil B grows larger. As compared with a case where a detection coil B having a constant transverse width is used as shown in FIG. 5B, it becomes possible to linearly change the inductance of the detection coil B with respect to the displacement of the detection body C. This makes it possible to enhance the linearity of the inductance change of the detection coil B with respect to the displacement of the target object changing together with the displacement of the detection body C.

While the width of the detection coil B is changed along the displacing direction of the detection body C in the foregoing description, it may be possible to change the width of the detection body C. In other words, the detection body C may be formed such that the transverse width thereof is decreased as the overlapping area of the detection body C and the detection coil B grows larger. In that case, it is equally possible to obtain the effects stated above. Alternatively, a distance between the detection body C and the detection coil B may be changed along the displacing direction of the detection body C. For example, as is the case in FIG. 4A, the detection body C may be bent downward such that the detection body C comes close to the detection coil B as the overlapping area grows larger. Further, as is the case in FIG. 4B, a thickness of the detection body C may be increased such that the detection body C comes close to the detection coil B as the overlapping area grows larger. In any case, it is possible to obtain the same effects as stated above.

### Second Embodiment

A position sensor in accordance with a second embodiment is substantially the same as the position sensor of the first embodiment. In the following description, the points differing from the first embodiment will only be described, and redundant description of the same configurations will be omitted.

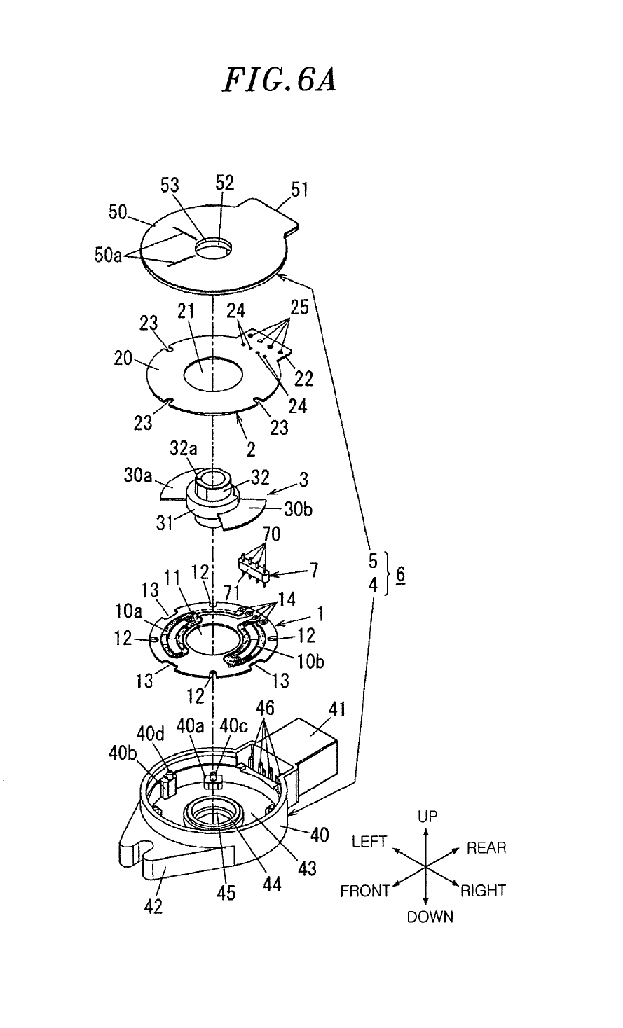

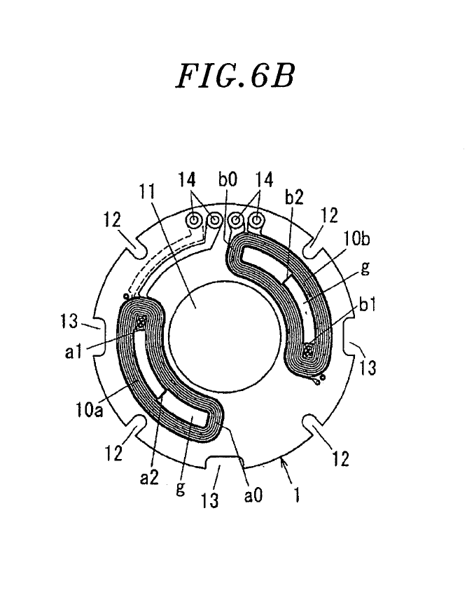

In the first embodiment, the respective detection bodies 30a and 30b or the respective detection coils 10a and 10b are formed such that the radial widths thereof are non-linearly changed. In the second embodiment, however, as shown in FIG. 6B, while each of the detection coils 10a and 10b is formed such that the radial width thereof kept constant, the detection coils of each of the first and the second dielectric substrate 1 and 2 include a plurality of first turns a0 and b0 wound to surround a space g having a specified length and extending along the displacing direction (the circumferential orbit) of each of the detection bodies 30a and 30b. The detection coils of each of the first and the second dielectric substrate 1 and 2 may further include two second turns a1 and a2, and b1 and b2 which are turned back and wound to extend across the corresponding space g (only the first dielectric substrate 1 is shown in FIG. 6B).

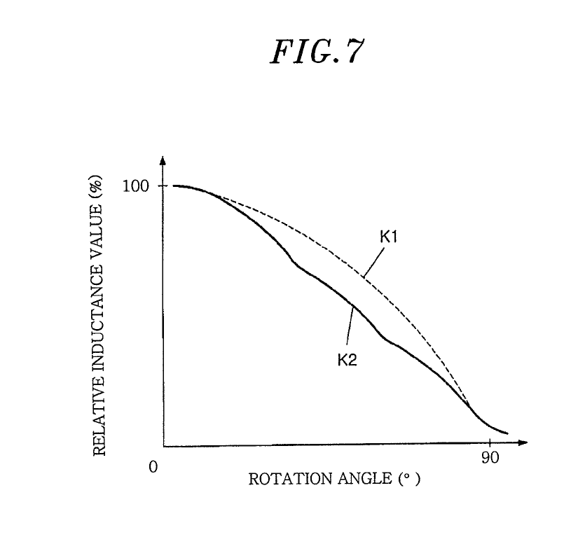

In a hypothetical case that the detection coils of each of the first and the second dielectric substrate 1 and is formed of only the first turns a0 and b0, the inductance change of the detection coils Co with respect to the rotation angle of the target object becomes non-linear as indicated by a dashed line K1 in FIG. 7. In FIG. 7, the inductance of the detection coils Co is 100% when the rotation angle of the target object is zero (in a state that the respective detection bodies 30a and 30b and the detection coils Co do not overlap with each other in the up-down direction). On the other hand, if the detection coils of each of the dielectric substrates 1 and 2 are provided with the second turns a1 and a2, and b1 and b2 as in the second embodiment, the magnetic flux density of the detection coils Co is changed in the turn-back sections of the second turns a1 and a2, and b1 and b2. By using the change in the magnetic flux density of the detection coils Co, the inductance change of the detection coils Co with respect to the rotation angle of the target object can be made substantially linear (see a solid line K2 in FIG. 7) as compared with the dashed line K1 shown in FIG. 7.

As described above, the detection coils of each of the dielectric substrates 1 and 2 of the second embodiment include the first turns a0 and b0 wound to surround the corresponding space g and the second turns a1 and a2, and b1 and b2 turned back and wound to extend across the corresponding space g. Therefore, the inductance change of the detection coils Co with respect to the displacement of the detection bodies 30a and 30b can be made substantially linear by changing the magnetic flux density of the detection coils Co in the turn-back sections of the second turns a1 and a2, and b1 and b2 of the respective detection coils. It is therefore possible to enhance the linearity of the inductance change of the detection coils Co with respect to the displacement of the target object changing together with the displacement of the detection bodies 30a and 30b.

In the second embodiment, the radial width of each of the coils of the dielectric substrates 1 and 2 is constant and is not changed when the second turns a1, a2, b1 and b2 are provided. Therefore, significant inductance reduction due to the increase of the radial width of each of the detection coils does not occur in the detection coils Co. Further, since there is no need to increase the radial width of each of the detection coils, it is possible to avoid an increase in the size of each of the dielectric substrates 1 and 2.

In the second embodiment, similar to the first embodiment, the respective detection bodies 30a and 30b are formed of a non-magnetic material. However, the respective detection bodies 30a and 30b may be formed of a magnetic material having high magnetic permeability. In that case, as set forth above, the characteristics of the inductance change with respect to the rotation angle of the target object are opposite to the characteristics available when the respective detection bodies 30a and 30b are formed of a non-magnetic material. That is to say, the inductance of the detection coils Co is increased as the rotation angle of the target object grows larger. In this case, it is equally possible to enhance the linearity of the inductance change characteristics with respect to the rotation angle of the target object.

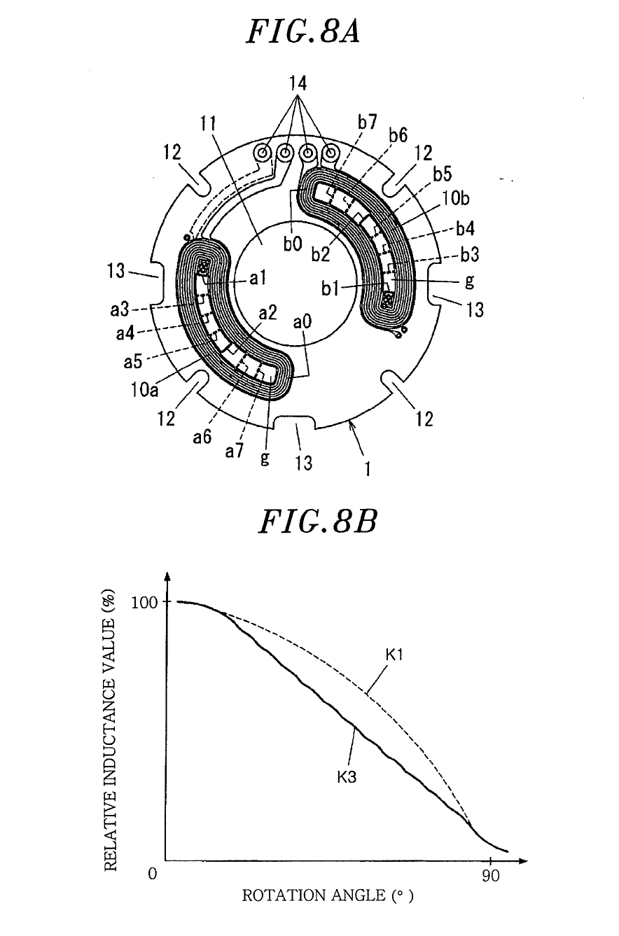

While the respective dielectric substrates 1 and 2 are formed of a single-layer substrate in the second embodiment, they may be formed of a multiple-layer substrate (e.g., a four-layer substrate). In that case, a pair of detection coils can be printed on each layer of the respective dielectric substrates 1 and 2. The detection coils of the respective layers are provided with second turns. It is preferred that, as shown in FIG. 8A, the second turns a1 to a7 and the second turns b1 to b7 of the detection coils of the layers are arranged so as not to overlap in the thickness direction of the respective dielectric substrates 1 and 2.

With this configuration, it is possible to change the magnetic flux density of the detection coils Co in the turn-back sections of the second turns a1 to a7 and b1 to b7. Therefore, as compared with a case where two second turns a1 and a2, and b1 and b2 are provided in the detection coils of the respective dielectric substrates 1 and 2, the inductance change of the detection coils Co with respect to the displacement of the detection bodies 30a and 30b can be made even more linear as shown in FIG. 8B.

It is not necessary that the second turns of the detection coils are arranged not to overlap in the thickness direction in all layers of the dielectric substrates 1 and 2. It is only necessary that the second turns of the detection coils of at least two layers do not overlap with each other in the thickness direction. For example, if each of the dielectric substrates 1 and 2 is formed of a four-layer substrate, the second turns of the detection coils of the first to fourth layers of the first dielectric substrate 1 may overlap in the thickness direction while the second turns of the detection coils of the first to third layers of the second dielectric substrate 2 may overlap in the thickness direction. In this case, the aforementioned conditions are satisfied if the second turns of the detection coils of the fourth layer of the second dielectric substrate 2 do not overlap with other second turns.

While the rotary position sensor in which the detection bodies 30a and 30b are displaced along the circumferential orbit has been described in the second embodiment, it may be possible to employ a linear-motion-type position sensor in which the detection body is displaced along a linear orbit as shown in FIG. 5A.

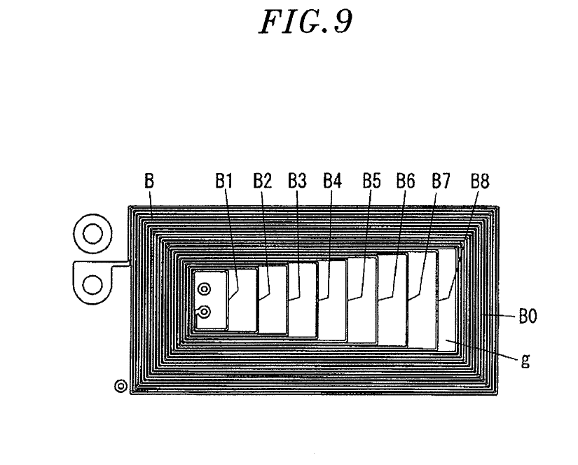

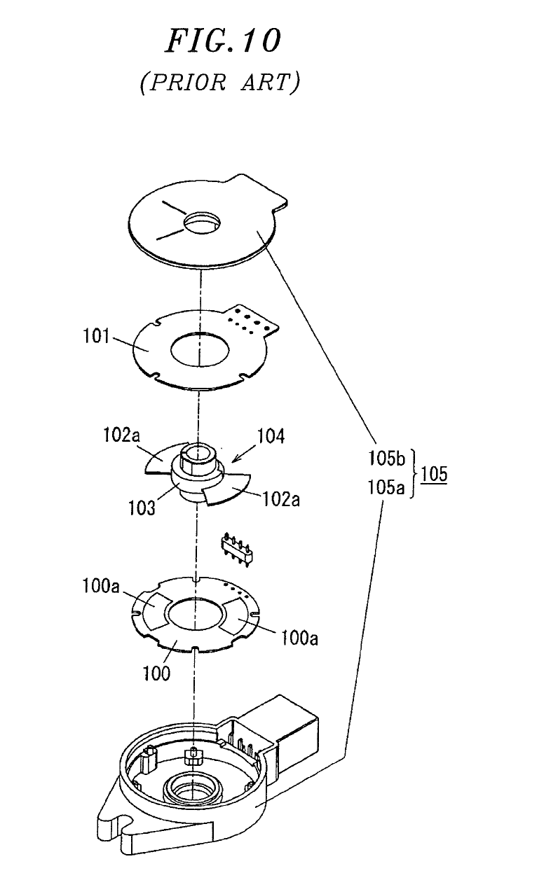

In this case, as shown in FIG. 9, the detection coil B includes a plurality of first turns B0 wound to surround a space g having a specified length and extending in the longitudinal direction of the detection coil B and a plurality of second turns B1 through B8 turned back and wound to extend across the space g. Therefore, as compared with a case where the detection coil B formed of only the first turn B0 is used as shown in FIG. 5B, the inductance change of the detection coil B with respect to the displacement of the detection body C can be made substantially linear. It is therefore possible to enhance the linearity of the inductance change of the detection coil B with respect to the displacement of the target object changing together with the displacement of the detection body C.

While the dielectric substrate A is formed of a single-layer substrate in the foregoing description, the dielectric substrate A may be formed of a multiple-layer substrate. The detection coil B may be provided in each layer of the substrate. Second turns may be provided in the detection coil B of each layer of the substrate. The second turns B1 through B8 of the detection coils of the layers may be arranged not to overlap with one another in the thickness direction of the dielectric substrate A. In that case, it is possible to obtain the same effects as stated above.

Further, it is not necessary that the second turns of the detection coils are arranged not to overlap in the thickness direction in all layers of the dielectric substrate A. It is only necessary that the second turns of the detection coils of at least two layers do not overlap with each other. For example, if the dielectric substrate A is formed of a four-layer substrate, the second turns of the detection coils of the first to third layers of the dielectric substrate A may overlap with one another in the thickness direction. In this case, the aforementioned conditions are satisfied if the second turns of the detection coil of the fourth layer of the dielectric substrate A do not overlap with other second turns.

While the invention has been shown and described with respect to the embodiments, it will be understood by those skilled in the art that various changes and modification may be made without departing from the scope of the invention as defined in the following claims.

What is claimed is:

1. A position sensor comprising:
a detection coil printed on a surface of a substrate formed of a dielectric material; and
a detection body arranged in an opposing relationship with the detection coil and displaced along a specified orbit with respect to the detection coil in response to a displacement of a target object,
wherein the displacement of the target object is detected based on an inductance of the detection coil varying depending on the displacement of the detection body, and
wherein at least one of the detection coil and the detection body is formed into such a shape that a change rate of the inductance of the detection coil with respect to the displacement of the detection body is kept constant.

2. The position sensor of claim 1, wherein the detection body is formed into such a shape that a radial width of the detection body is changed along a displacing direction of the detection body.

3. The position sensor of claim 1, wherein the detection coil is formed into such a shape that a radial width of the detection coil is changed along a displacing direction of the detection body.

4. The position sensor of claim 1, wherein the detection body is formed into such a shape that a distance between the detection body and the detection coil is changed along a displacing direction of the detection body.

5. A position sensor comprising:
a detection coil printed on a surface of a substrate formed of a dielectric material; and
a detection body arranged in an opposing relationship with the detection coil and displaced along a specified orbit with respect to the detection coil in response to a displacement of a target object,
wherein the displacement of the target object is detected based on an inductance of the detection coil varying depending on the displacement of the detection body, and
wherein the detection coil includes a plurality of first turns wound to surround a space having a specified length and extending in a displacing direction of the detection body and one or more second turns turned back and wound to extend across the space.

6. The position sensor of claim 5, wherein the substrate is formed of a multi-layer substrate, and
wherein the detection coil is printed on each layer of the substrate, and the second turns of detection coils of at least two layers of the substrate are arranged not to overlap with each other in a thickness direction of the substrate.
